(19) United States
(12) Patent Application Publication
(10) Pub. No.: US 2012/0069696 A1
(43) Pub. Date: Mar. 22, 2012

(54) PAINT STIRRER WITH PAINT BRUSH HOLDER

(76) Inventor: René Johan Van Geer, AJ Rijswijk (NL)

(21) Appl. No.: 13/322,678

(22) PCT Filed: May 26, 2010
(86) PCT No.: PCT/NL2010/050315

§ 371 Date: Nov. 28, 2011

(30) Foreign Application Priority Data
May 27, 2009 (NL) 1036994

(51) Int. Cl. B01F 13/00

(52) U.S. Cl. 366/129

(57) ABSTRACT

Paint stirrer with an elongate narrow main shape, which under the action of gravity can stably stand in a diagonal position in a paint can without the need to Mount it to the edge of the can, characterised in that the brush can be stably supported relative to the paint stirrer in such a manner that the brush hairs extend substantially parallel to the paint stirrer and downward above or in the opening of the can. This offers the advantage that paint rests flowing out the brush, stay inside the can.

The invention relates to a paint stirrer with integrated paint brush holder.

U.S. Pat. No. 2,492,042 (published 1949) discloses a of metal wire bent paint stirrer with integral brush holder, wherein the paint stirrer must be clamped to the edge of the paint can, whereafter the grip of the brush more or less perpendicular can be inserted into the paint stirrer, such that the brush obtains a stable position above the paint can. This product, which is non-spatula like, however designed as an egg clutch, only functions for paint cans with a large diameter and/or for brushes with short hairs, since both with small paint cans and with long brushes paint drops can drop besides the paint can. While the brush is inserted with its stem through the for it designed opening in the brush holder, the painter has the risk to get paint rests at his hands. Furthermore it can not always be avoided that the brush hairs are somewhat upward directed and the liquid paint rests between the brush hairs—under influence of gravity —will flow in towards the stem of the paint brush, which can shorten the life span of the paint brush.

U.S. Pat. No. 3,536,285 (published 1970) discloses a with a clamping means to the paint can clamping bracket to which the paint brush can be mounted by mounting means, such that the paint brush will stably vertically suspend in the paint can without bearing at the ends of the brush hairs. This bracket is unsuitable to stir the paint. U.S. Pat. No. 4,014,453 (published 1977) discloses a with a clamping means to the paint can clamping bracket and the paint brush can loose standing at the ends of the brush hairs be located on it such that the paint brush can be stably vertically located in the paint can. Also this bracket is unsuited to stir paint. EP-A-1.279.523 (published 2003) discloses a loose in the paint can to be located paint stir rod without a means to stably support to it a paint brush.

The object of the present invention is to solve one or more disadvantages of the prior art. This object is obtained with a paint stirrer according to claim 1. The subclaims provide basis for advantageous embodiments.

This invention will be illustrated by way of presently most preferred embodiments, shown in the drawing.

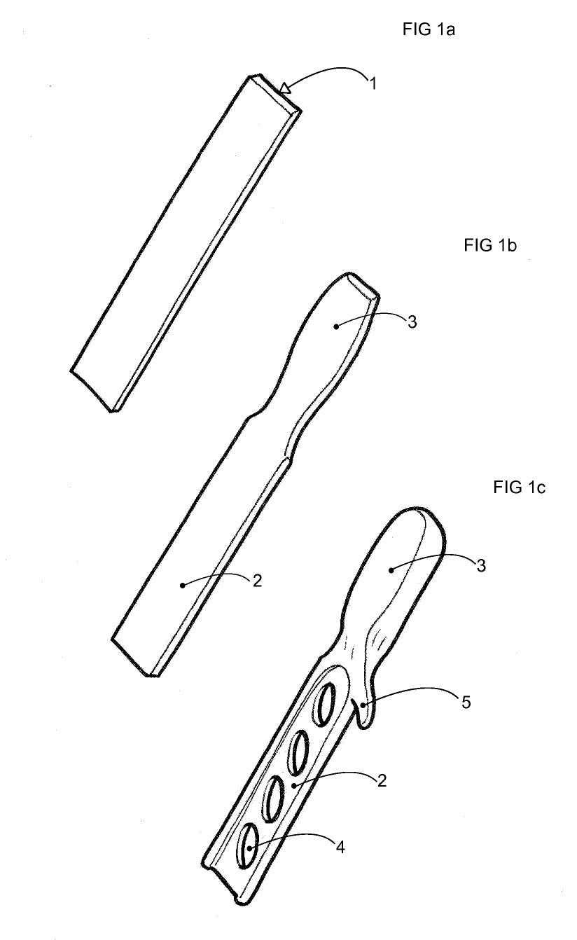

FIG. 1 shows some already known embodiments of the paint stirrer.

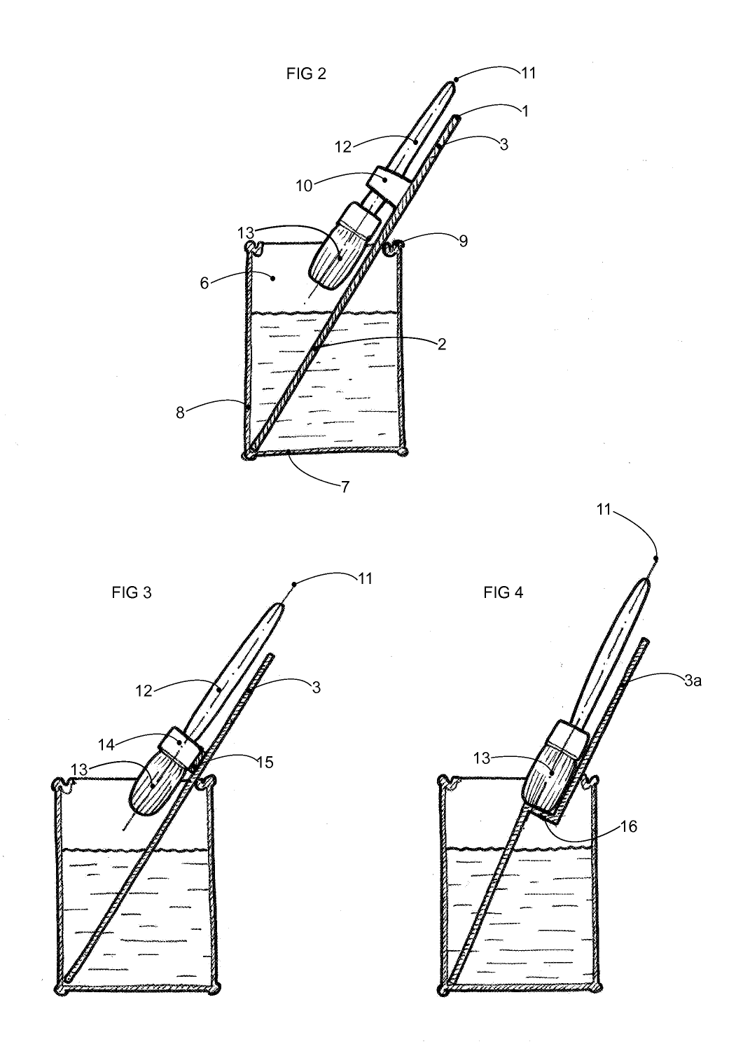

FIGS. 2, 3 and 4 show possible functioning principles of the invention and

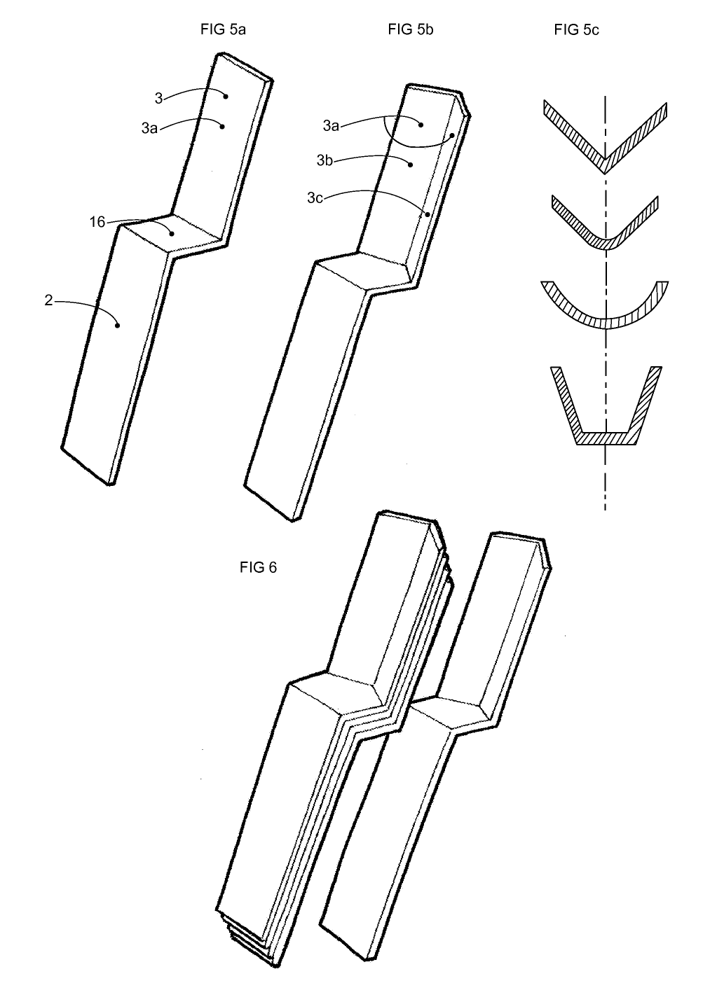

FIGS. 5 to 11 show possible embodiments of it.

FIG. 1a shows the traditional embodiment of the paint stirrer 1. An elongate flat and right angled model, obtaining its shape from the traditional fabrication method, namely cutting wood.

FIG. 1b shows a variant of the paint stirrer of FIG. 1a, wherein the stirring part 2 is still right angled, while at the location of the grip 3 a smooth contour is provided. paint stirrers according to embodiments of FIGS. 1a and 1b are presently also fabricated from injection moulded plastic in stead of wood. Plastic can be better cleaned compared to wood, but besides the plastic embodiments provide no specific application advantages compared to items of wood.

FIG. 1c shows a modern plastic variant, wherein the possibilities of injection moulding as fabrication technique are better used. In the example shown holes 4 are added to the stirring part 2 and at the location of the transition between stirring part 2 and grip 3 there is a hook 5 with which the paint stirrer can be hooked to the edge of a paint can. The grip 3 has a spaced smooth shape to improve the ergonomics, but apart from an improvement of ease of use, no new function is added.

FIG. 2 shows a possible embodiment for the invention by way of a cross section of a paint stirrer 1 which stands diagonally in a paint can 6. The paint stirrer 1 stands stable, because the end of the stirring part 2 is caught between bottom 7 and side wall 8 of the can, while the downward directed side of the grip 3 bears against the opposite inner edge 9 of the can.

At the upward directed side of this grip 3 the clamp 10 is mounted, with which a brush 11 at the location of the stem 12 can be temporarily fixated to the paint stirrer 1, in such a position that it extends substantially parallel to the paint stirrer 1 and with the hairs 13 downward, above or in the opening of the can 6.

FIG. 3 shows a variant to the paint stirrer of FIG. 2, based on the fact that hairs at the transition between stem 12 and hairs 13 are typically provided with a metal edge 14. By replacing the mechanical clamp 10 of FIG. 2 at the grip 3 by a magnet 15, the brush 11 at the location of the metal edge 14 by means of magnetic adhesion can be mounted in the desired position to the paint stirrer for short or long term.

FIG. 4 shows another embodiment of the invention by way of a cross section comparable to FIGS. 2 and 3. This time the paint stirrer has however no clamp or magnet, but the brush 11 bears in its longitudinal direction with the hairs 13 at a horizontal supporting face 16 which is more or less perpendicular to the longitudinal direction of the brush positioned. The brush is in a direction perpendicular to its longitudinal direction supported by a vertical supporting face 3a which also functions as grip. The fact that the paint stirrer stands in the can not precisely vertical but diagonal, means that the brush and the brush holder in the use position both stand slanted compared to the vertical and the brush bears stable against both supporting faces 3a, 16 by means of gravity.

FIG. 5a shows a perspective of the in FIG. 4 described device, with grip 3 and supporting face 3a, horizontal supporting face 16 and stirring part 2. FIG. 5b shows an embodiments of this device, wherein supporting face 3a is V-shaped. The magnitude of the angle between the part faces 3b, 3c which commonly provide the V-shape, has influence to the sideways stability of the brush relative to the holder, or the stability in the directions perpendicular to the cross sectional face in FIG. 4. FIG. 5c shows some possible variants to the V-shaped section of the supporting face 3a, as is illustrated at FIG. 5b.

FIG. 6 shows how this device—despite the spaced structure —can still be nested in a compact manner. Nesting optimises packing volume and material during production, storage and transport.

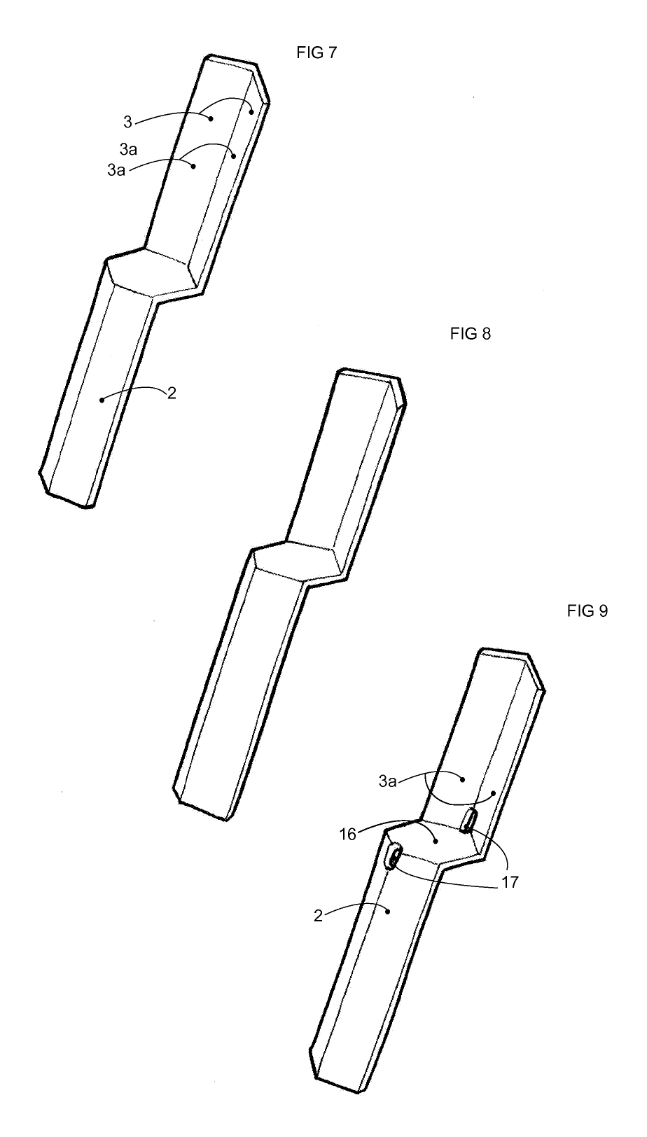

FIG. 7 shows an embodiment of the invention, which is substantially designed in mirror shape by which both functional parts, being stirring part 2 and grip 3 or supporting face 3a, are substantially identical.

FIG. 8 shows an embodiment of the invention, wherein both parts of the paint stirrer are indeed substantially identical, but differ in length, such that a single paint stirrer fits in several can formats.

FIG. 9 shows an embodiment of the invention, provided with one or more openings 17 in or close to the transition between the vertical supporting face 3a and the horizontal supporting face 16, along which paint from the hairs can flow back to the can.

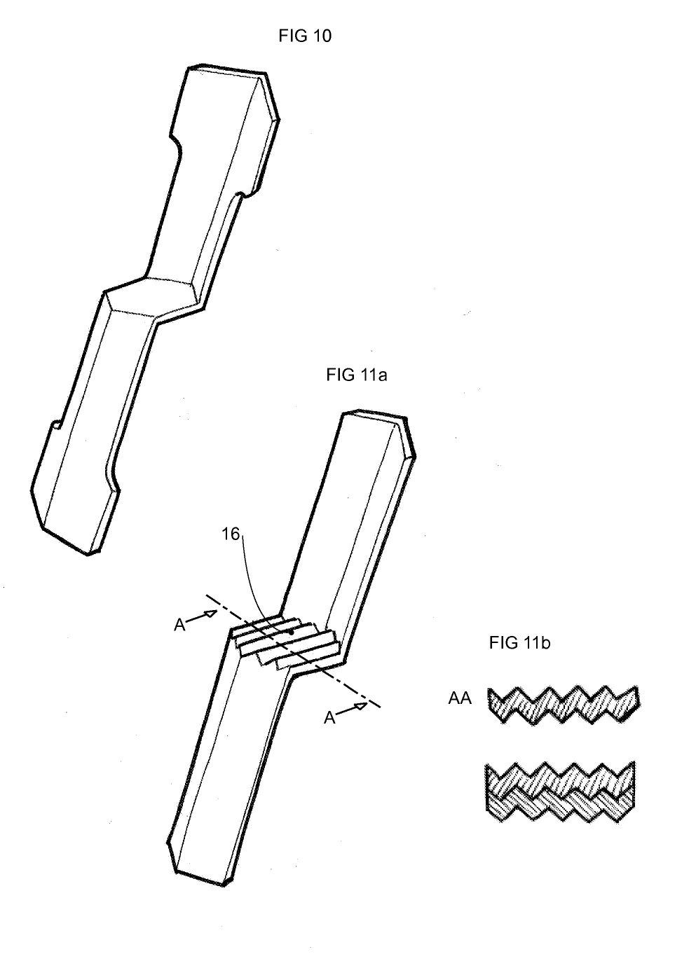

FIG. 10 shows an embodiment of the invention, wherein both ends are wider compared to the central part. This widening means additional stability for sideways support of in particular thick brushes, and improvement of the mixing performance. This widening also provides improvement of the sideways stability of the paint stirrer relative to the bottom of the can. Relative narrowing of the central part yields material savings and lowering of fabrication costs, without decrease of functionality.

FIG. 11a shows and embodiment of the invention, wherein the horizontal supporting face 16 is ribbed to locally improve the mechanical stability and to avoid sideways sliding of the brush relative to the horizontal supporting face 16. FIG. 11b shows in a cross section AA of the horizontal supporting face 16 (how this ribs can be provided at both sides without negative influence to the nesting capability of the product.

Also different embodiments belong to the invention. Features of different in here disclosed embodiments can in different manners be combined and different aspects of some features are regarded mutually exchangeable. All described or in the drawing disclosed features provide as such or in arbitrary combination the subject matter of the invention, also independent from their arrangement in the claims or their referral.

1-9. (canceled)

10. In combination a separate paint brush and an inclined in a with paint filled paint can located separate paint stirrer (1), spatula like, with an elongate narrow shape, which under influence of gravity stands stable in a diagonal position in said paint can, free bearing against the upper edge of said can without this paint stirrer being fixed to the upper edge of the can (6), and said paint stirrer provided with engagement means (15, 16) in releasable engagement with said paint brush (11) such that said brush is positioned stable relative to the paint stirrer (1) and exclusively supported by said paint stirrer such that the hairs (13) of said brush are parallel to this paint stirrer and downwards directed provided in the opening of the can (6) and remote from the opening edge, sides and bottom of the can and the grip (12) extends parallel to the paint stirrer (1) upwards from the hairs and also remote from the opening edge, sides and bottom of the can.

11. Device according to claim 10, wherein the grip (3) of the paint stirrer has a mechanical feature, e.g. a clamp, with which said brush (11) is releasably mounted to said paint stirrer, e.g. as shown in FIG. 2, e.g. be clamped or hooked, e.g. at the location of the brush stem (12).

12. Device according to claim 10, wherein said brush is mounted to the paint stirrer by means of magnetic means.

13. Device according to claim 12, wherein said brush (11) has a magnetisable metal edge (14) magnetically mounted to a permanent magnet (15) in the grip (3) of the paint stirrer, e.g. as shown in FIG. 3, such that brush and stirrer can be easily separated by breaking the mutual magnetic bond.

14. Device according to claim 10, wherein a midway along its length located horizontal supporting face (16) in the paint stirrer, perpendicular positioned relative to the longitudinal direction of the brush (11), supports this brush in its longitudinal direction, while a vertical supporting face (3a), which is an integral part of the grip (3) of the paint stirrer, supports this brush in at least one direction perpendicular to its own longitudinal direction, wherein the support in one or both directions is loose or free laying, in other words that this support allows free sliding of the brush across the surface of the paint stirrer, as e.g. FIG. 4 shows.

15. Device according to claim 14, wherein the grip (3) or vertical supporting face (3a) of the paint stirrer, which is located parallel to the longitudinal direction of the brush (11), is buckled or curved such that this face is made of two partial faces (3b, 3c), wherein the mutual secant of these partial faces (3b, 3c) is located parallel to the longitudinal direction of the brush (11), whereby the partial faces (3b, 3c) together support this brush at both sides.

16. Device according to claim 15, wherein the grip of the paint stirrer has a trough shape to sideways support the brush, e.g. as shown in FIG. 5c.

17. Device according to claim 14, wherein the horizontal supporting face (16) of the paint stirrer has a stiff/non-slippery surface, e.g. a ribbed structure, preferably wherein parallel grooves extend perpendicular to the surface of the grip, e.g. as shown in FIG. 11a.

18. Device according to claim 14, wherein said paint stirrer is provided with one or more drain openings (17) in or close to the connection between the vertical supporting face (3a) and the horizontal supporting face (16)

19. Device according to claim 10, wherein said paint stirrer has one or more of the following features:
has a nesting shape, e.g. as shown in FIG. 6, such that the volume during storage and transport of a package stacked paint stirrers is minimised;
is substantially symmetrically, whereby the stirring part (2) can function as grip (3) and vice versa;
both parts have a different length;
comprises two staggered in mutual extension extending elongated parts (2, 3) which are connected to each other by a an angle of preferably 90 degrees therewith making supporting face (16);
comprises to elongated parts (2, 3) and a supporting face (16) which observed in side view provide a substantial Z-shaped assembly of which the legs (2, 3) are preferably long relative to the web (16);
is at one or both ends wider than in the centre;
is made by deformation, preferably pressing, of plate material or by moulding, preferably injection moulding;
has a substantially closed surface;
is substantially plate or strip like;
has observed in side view a, preferably singular, stepped shape of which the step provides a supporting face onto which brush hairs with the free ends will bear to retain the brush longitudinally;
is not of metal wire;
is of non-metal material;
is of plastic or polymer material;
at the horizontal supporting face (16) the brush hairs will bear with their free end to retain the brush longitudinally;
is designed to engage the brush hairs to retain them longitudinally and perpendicular thereto;
is designed to, in inclined position, stably support the brush in upright position exclusively by gravity action which keeps two spaced parts of the brush, such as the lower end and a side distal of the lower end, respectively, pressed against a relevant face (3, 3a) of the paint stirrer;
the stirrer (1) has a length to bear loosely at the bottom of the can with its lower edge while the top end or grip (3) and also the grip (12) of the brush project above the can;
lacks means for mounting to the can;
lacks a substantially U-shaped part (such as shown in FIG. 3 of U.S. Pat. No. 4,014,453) wherein from above the brush with the hairs downward directed must be placed to retain the hairs downwards and capture them sideways;
is apart from the engagement means (15, 16) free from projections along its length.
